(19) United States
(12) Patent Application Publication
(10) Pub. No.: US 2017/0305449 A1
(43) Pub. Date: Oct. 26, 2017

(54) Train Brake Control System And Method

(71) Applicant: Westinghouse Air Brake Technologies Corporation, Wilmerding, PA (US)

(72) Inventor: Richard S Klemanski, Walkersville, MD (US)

(21) Appl. No.: 15/135,792

(22) Filed: Apr. 22, 2016

(51) Int. Cl. B61L 27/04; B61H 9/00; B60T 8/17; B61H 11/02; B61H 11/06; B61H 13/00

(52) U.S. Cl. CPC B61L 27/04; B61H 11/06; B61H 13/00; B60T 8/1705; B61H 11/02; B61H 9/006; B61L 2201/00

(57) ABSTRACT

A brake control system and method for a train having a lead locomotive or control car, at least one trailing locomotive or control car and, optionally, at least one railroad car. The lead locomotive or control car generates data representing an independent brake demand and data representing an automatic brake demand and transmits the data representing an independent brake demand and the data representing an automatic brake demand to the at least one trailing locomotive or control car. The at least one trailing locomotive or control car receives data representing an independent brake demand and data representing an automatic brake demand and controls a brake cylinder pressure of the at least one trailing locomotive or control car based on the data representing an independent brake demand and the data representing an automatic brake demand.

### BACKGROUND OF THE INVENTION

### Field of the Invention

Disclosed embodiments relate generally to vehicle systems and control processes, such as railway systems including trains travelling in a track or rail network, and in particular to a train brake control system and method that provide improved train brake control in railway networks, such as in connection with automatic electronically-controlled pneumatic (ECP) brake control.

### Description of Related Art

As is known in the field of train control, and when operating a train having multiple locomotives or control cars, the lead and trailing locomotives are interconnected with various pneumatic pipes, including a “brake pipe” and an “independent apply and release pipe” also known as the “20-pipe” or “No. 3 Control Pipe”. These two pipes operate two separate brake systems when a train is operating in pneumatic mode, i.e., automatic or pneumatic braking via the brake pipe and independent braking via the control pipe.

The brake pipe, which is controlled through an operator's automatic brake handle, controls a train-wide brake application in an inverse manner, where a fully-charged brake pipe causes brakes on the locomotive and cars to release and charge reservoirs, while a reduction in the brake pipe pressure causes a volume of air, inversely proportional to the amount of drop in brake pipe pressure, to be applied to the brake cylinders of the locomotives and cars. Typically, for a given reduction in brake pipe, an equal brake cylinder pressure is generated at both the lead and trailing locomotives, regardless of the class of the locomotive.

The independent apply and release pipe, which is also known as the “control pipe”, communicates a control pressure between the lead locomotive and the close-coupled trailing locomotives for purposes of controlling the brake cylinder pressures of the trailing locomotives in response to independent braking. This pressure is generated at the lead locomotive by movement of an operator's independent brake handle, and generates a pressure proportional to the handle position from 0 PSI (in the release position) to typically 45 PSI (at the full apply position). Each locomotive senses this pressure and applies a local multiplier to the sensed control pressure to generate a resulting brake cylinder pressure. Although the control pressure may be “standardized” among locomotives, the desired brake cylinder pressure may be very different due to the weights of the locomotives, and characteristics of the brake shoe material of the locomotives.

When the train is operating in pneumatic mode, the pneumatic path of the control pipe is dedicated to independent braking. However, when the train is operating in electronically-controlled pneumatic (ECP) brake mode, this same pneumatic independent brake path, i.e., the control pipe, is used for both independent and automatic braking. Due to the fact that the brake pipe does not reduce while in ECP mode, and is only used as an air “supply” pipe, it is necessary to use the control pipe to convey automatic ECP brake demand to trailing locomotives.

The lead locomotive has knowledge of what constitutes the control pipe demand pressure and the respective percentages thereof (independent braking vs. automatic braking vs. a combination thereof), but the trailing locomotives do not have such knowledge. The control pipe pressure may be wholly due to an independent demand, wholly due to an automatic demand, or due to a combination of the two. Accordingly, one issue is that arises involves the multiplier functionality, which should typically only be applied to the independent braking portion of the demand. In conventional ECP braking systems, the trailing locomotives are not equipped to determine the source of the control pipe demand, and may incorrectly apply the multiplier to demand that is present in the control pipe due to automatic braking demand. This can result in over-braking or under-braking, depending on the implementation and the difference in the locomotive's multipliers.

For at least these reasons, there is a need in the art for an improved train brake control system and method.

### SUMMARY OF THE INVENTION

Generally, provided are an improved train brake control system and computer-implemented method for use in connection with trains travelling in a track network. Preferably, provided are a train brake control system and computer-implemented method that provide improved control of automatic and independent brake cylinder pressures on multi-unit locomotives operating in electronically-controlled pneumatic (ECP) braking modes. Preferably, provided are a train brake control system and computer-implemented method that account for a need to control brake cylinder pressures at different levels for different types of locomotives by using communications-based demands instead of pneumatic pressures.

In one preferred and non-limiting embodiment or aspect, provided is a brake control system for a train having a lead locomotive or control car, at least one trailing locomotive or control car and, optionally, at least one railroad car, the system comprising: on the lead locomotive or control car: an on-board computer programmed or configured to implement or facilitate at least one train action; and a communication device in communication with the on-board computer and programmed or configured to receive, transmit, and/or process data signals; wherein the on-board computer of the lead locomotive or control car is programmed or configured to generate data representing an independent brake demand and data representing an automatic brake demand; and wherein the communication device of the lead locomotive or control car is programmed or configured to directly or indirectly transmit the data representing an independent brake demand and the data representing an automatic brake demand to the at least one trailing locomotive or control car.

In one preferred and non-limiting embodiment or aspect, the lead locomotive or control car is operating in an electronically-controlled pneumatic (ECP) brake mode.

In one preferred and non-limiting embodiment or aspect, the data representing an independent brake demand defines a percentage application of the independent brake demand.

In one preferred and non-limiting embodiment or aspect, the data representing an automatic brake demand defines a percentage application of the automatic brake demand.

In one preferred and non-limiting embodiment or aspect, the on-board computer of the lead locomotive or control car is programmed or configured to: control a pressure in a brake pipe connecting the lead locomotive or control car to the at least one trailing locomotive or control car to remain charged; and control a pressure in a control pipe connecting the lead locomotive or control car to the at least one trailing locomotive or control car based on the independent brake demand and the automatic brake demand.

In one preferred and non-limiting embodiment or aspect, the communication device of the lead locomotive or control car is programmed or configured to directly or indirectly transmit the data representing an independent brake demand and the data representing an automatic brake demand to the at least one trailing locomotive or control car via an electronically-controlled pneumatic (ECP) brake trainline connecting the lead locomotive or control car to the at least one trailing locomotive or control car.

In one preferred and non-limiting embodiment or aspect, the on-board computer of the lead locomotive or control car is programmed or configured to generate the data representing an independent brake demand based at least partially on a position of an independent brake handle of the lead locomotive or control car, and generate the data representing an automatic brake demand based at least partially on the position of an automatic brake handle of the lead locomotive or control car.

In one preferred and non-limiting embodiment or aspect, the brake control system further comprises: on the at least one trailing locomotive or control car: an on-board computer programmed or configured to implement or facilitate at least one train action; and a communication device in communication with the on-board computer and programmed or configured to receive, transmit, and/or process data signals; wherein the communication device of the at least one trailing locomotive or control car is programmed or configured to receive the data representing an independent brake demand and the data representing an automatic brake demand; and wherein the on-board computer of the at least one trailing locomotive or control car is programmed or configured to control a brake cylinder pressure of the at least one trailing locomotive or control car based on the data representing an independent brake demand and the data representing an automatic brake demand.

In one preferred and non-limiting embodiment or aspect, provided is a brake control system for a train having a lead locomotive or control car, at least one trailing locomotive or control car and, optionally, at least one railroad car, the system comprising: on the at least one trailing locomotive or control car: an on-board computer programmed or configured to implement or facilitate at least one train action; and a communication device in communication with the on-board computer and programmed or configured to receive, transmit, and/or process data signals; wherein the communication device of the at least one trailing locomotive or control car is programmed or configured to receive data representing an independent brake demand and data representing an automatic brake demand; and wherein the on-board computer of the at least one trailing locomotive or control car is programmed or configured to control a brake cylinder pressure of the at least one trailing locomotive or control car based on the data representing an independent brake demand and the data representing an automatic brake demand.

In one preferred and non-limiting embodiment or aspect, the at least one trailing locomotive or control car is operating in an electronically-controlled pneumatic (ECP) brake mode.

In one preferred and non-limiting embodiment or aspect, the data representing an independent brake demand defines a percentage application of the independent brake demand.

In one preferred and non-limiting embodiment or aspect, the data representing an automatic brake demand defines a percentage application of the automatic brake demand.

In one preferred and non-limiting embodiment or aspect, the communication device of the at least one trailing locomotive or control car is programmed or configured to receive the data representing an independent brake demand and the data representing an automatic brake demand via an electronically-controlled pneumatic (ECP) brake trainline connecting the lead locomotive or control car to the at least one trailing locomotive or control car.

In one preferred and non-limiting embodiment or aspect, provided is a brake control system for a train having a lead locomotive or control car, at least one trailing locomotive or control car and, optionally, at least one railroad car, the lead locomotive or control car and the at least one trailing locomotive or control car connected by a brake pipe and a control pipe, the system comprising: on the lead locomotive or control car: an on-board computer programmed or configured to implement or facilitate at least one train action; and a communication device in communication with the on-board computer and programmed or configured to receive, transmit, and/or process data signals; wherein the on-board computer of the lead locomotive or control car is programmed or configured to determine if the lead locomotive or control car is in an electronically-controlled pneumatic (ECP) brake mode; wherein, if the lead locomotive or control car is in the ECP brake mode, the on-board computer of the lead locomotive or control car is programmed or configured to generate data representing an independent brake demand based at least partially on a position of an independent brake handle of the lead locomotive or control car and data representing an automatic brake demand based at least partially on a position of an automatic brake handle of the lead locomotive or control car, and the communication device of the lead locomotive or control car is programmed or configured to transmit the data representing an independent brake demand and the data representing an automatic brake demand to the at least one trailing locomotive or control car; and wherein, if the lead locomotive is not in the ECP brake mode, the on-board computer of the lead locomotive or control car is programmed or configured to control a brake cylinder pressure of the lead locomotive or control car based on a pressure of the brake pipe, a pressure of the control pipe, and a multiplier associated with the lead locomotive.

In one preferred and non-limiting embodiment or aspect, the communication device of the lead locomotive or control car is programmed or configured to directly or indirectly transmit the data representing an independent brake demand and the data representing an automatic brake demand to the at least one trailing locomotive or control car via an ECP brake trainline connecting the lead locomotive or control car to the at least one trailing locomotive or control car.

In one preferred and non-limiting embodiment or aspect, the data representing an independent brake demand defines a percentage application of the independent brake demand, and wherein the data representing an automatic brake demand defines a percentage application of the automatic brake demand.

In one preferred and non-limiting embodiment or aspect, the brake control system further comprises: on the at least one trailing locomotive or control car: an on-board computer programmed or configured to implement or facilitate at least one train action; and a communication device in communication with the on-board computer and programmed or configured to receive, transmit, and/or process data signals; wherein the on-board computer of the at least one trailing locomotive or control car is programmed or configured to determine if the at least one trailing locomotive or control car is in the electronically-controlled pneumatic (ECP) brake mode; wherein, if the at least one trailing locomotive or control car is in the ECP brake mode, the on-board computer of the at least one trailing locomotive is programmed or configured to determine if an ECP communications path is active, and wherein if the ECP communications path is active the communication device of the at least one trailing locomotive or control car is programmed or configured to receive the data representing an independent brake demand and the data representing an automatic brake demand via the ECP communications path, and the on-board computer of the at least one trailing locomotive or control car is programmed or configured to control a brake cylinder pressure of the at least one trailing locomotive or control car based on the data representing an independent brake demand and the data representing an automatic brake demand; and wherein, if the at least one trailing locomotive is not in the ECP brake mode or the ECP communications path is not active, the on-board computer of the at least one trailing locomotive is programmed or configured to control the brake cylinder pressure based on the pressure of the brake pipe, the pressure of the control pipe, and a multiplier associated with the at least one trailing locomotive.

In one preferred and non-limiting embodiment or aspect, provided is a brake control system for a train having a lead locomotive or control car, at least one trailing locomotive or control car and, optionally, at least one railroad car, the lead locomotive or control car and the at least one trailing locomotive or control car connected by a brake pipe and a control pipe, the system comprising: on the at least one trailing locomotive or control car: an on-board computer programmed or configured to implement or facilitate at least one train action; and a communication device in communication with the on-board computer and programmed or configured to receive, transmit, and/or process data signals; wherein the on-board computer of the at least one trailing locomotive or control car is programmed or configured to determine if the at least one trailing locomotive or control car is in an electronically-controlled pneumatic (ECP) brake mode; wherein, if the at least one trailing locomotive or control car is in the ECP brake mode, the on-board computer of the at least one trailing locomotive is programmed or configured to determine if an ECP communications path is active, wherein if the ECP communications path is active, the communication device of the at least one trailing locomotive or control car is programmed or configured to receive data representing an independent brake demand and data representing an automatic brake demand via the ECP communications path, and the on-board computer of the at least one trailing locomotive or control car is programmed or configured to control a brake cylinder pressure of the at least one trailing locomotive or control car based on the data representing an independent brake demand and the data representing an automatic brake demand; and wherein, if the at least one trailing locomotive is not in the ECP brake mode or the ECP communications path is not active, the on-board computer of the at least one trailing locomotive is programmed or configured to control the brake cylinder pressure based on a pressure of the brake pipe, a pressure of the control pipe, and a multiplier associated with the at least one trailing locomotive.

In one preferred and non-limiting embodiment or aspect, the communication device of the at least one trailing locomotive or control car is programmed or configured to receive the data representing an independent brake demand and the data representing an automatic brake demand via an ECP brake trainline connecting the lead locomotive or control car to the at least one trailing locomotive or control car.

In one preferred and non-limiting embodiment or aspect, the data representing an independent brake demand defines a percentage application of the independent brake demand, and wherein the data representing an automatic brake demand defines a percentage application of the automatic brake demand.

In one preferred and non-limiting embodiment or aspect, provided is a computer-implemented method for brake control for a train having a lead locomotive or control car, at least one trailing locomotive or control car and, optionally, at least one railroad car, the method comprising: generating data representing an independent brake demand and data representing an automatic brake demand; and directly or indirectly transmitting the data representing an independent brake demand and the data representing an automatic brake demand to the at least one trailing locomotive or control car.

In one preferred and non-limiting embodiment or aspect, the lead locomotive or control car is operating in an electronically-controlled pneumatic (ECP) brake mode.

In one preferred and non-limiting embodiment or aspect, the data representing an independent brake demand defines a percentage application of the independent brake demand, and wherein the data representing an automatic brake demand defines a percentage application of the automatic brake demand.

In one preferred and non-limiting embodiment or aspect, the method further comprises: controlling a pressure in a brake pipe connecting the lead locomotive or control car to the at least one trailing locomotive or control car to remain charged; and controlling a pressure in a control pipe connecting the lead locomotive or control car to the at least one trailing locomotive or control car based on the independent brake demand and the automatic brake demand.

In one preferred and non-limiting embodiment or aspect, the method further comprises directly or indirectly transmitting the data representing an independent brake demand and the data representing an automatic brake demand to the at least one trailing locomotive or control car via an electronically-controlled pneumatic (ECP) brake trainline connecting the lead locomotive or control car to the at least one trailing locomotive or control car.

Further embodiments or aspects will not be described and set forth in the following numbered clauses:

Clause 1: A brake control system for a train having a lead locomotive or control car, at least one trailing locomotive or control car and, optionally, at least one railroad car, the system comprising: on the lead locomotive or control car: an on-board computer programmed or configured to implement or facilitate at least one train action; and a communication device in communication with the on-board computer and programmed or configured to receive, transmit, and/or process data signals; wherein the on-board computer of the lead locomotive or control car is programmed or configured to generate data representing an independent brake demand and data representing an automatic brake demand; and wherein the communication device of the lead locomotive or control car is programmed or configured to directly or indirectly transmit the data representing an independent brake demand and the data representing an automatic brake demand to the at least one trailing locomotive or control car.

Clause 2: The brake control system of clause 1, wherein the lead locomotive or control car is operating in an electronically-controlled pneumatic (ECP) brake mode.

Clause 3: The brake control system of clause 1 or 2, wherein the data representing an independent brake demand defines a percentage application of the independent brake demand.

Clause 4: The brake control system of any of clauses 1-3, wherein the data representing an automatic brake demand defines a percentage application of the automatic brake demand.

Clause 5: The brake control system of any of clauses 1-4, wherein the on-board computer of the lead locomotive or control car is programmed or configured to: control a pressure in a brake pipe connecting the lead locomotive or control car to the at least one trailing locomotive or control car to remain charged; and control a pressure in a control pipe connecting the lead locomotive or control car to the at least one trailing locomotive or control car based on the independent brake demand and the automatic brake demand.

Clause 6: The brake control system of any of clauses 1-5, wherein the communication device of the lead locomotive or control car is programmed or configured to directly or indirectly transmit the data representing an independent brake demand and the data representing an automatic brake demand to the at least one trailing locomotive or control car via an electronically-controlled pneumatic (ECP) brake trainline connecting the lead locomotive or control car to the at least one trailing locomotive or control car.

Clause 7: The brake control system of any of clauses 1-6, wherein the on-board computer of the lead locomotive or control car is programmed or configured to generate the data representing an independent brake demand based at least partially on a position of an independent brake handle of the lead locomotive or control car, and generate the data representing an automatic brake demand based at least partially on the position of an automatic brake handle of the lead locomotive or control car.

Clause 8: The brake control system of any of clauses 1-7, further comprising: on the at least one trailing locomotive or control car: an on-board computer programmed or configured to implement or facilitate at least one train action; and a communication device in communication with the on-board computer and programmed or configured to receive, transmit, and/or process data signals; wherein the communication device of the at least one trailing locomotive or control car is programmed or configured to receive the data representing an independent brake demand and the data representing an automatic brake demand; and wherein the on-board computer of the at least one trailing locomotive or control car is programmed or configured to control a brake cylinder pressure of the at least one trailing locomotive or control car based on the data representing an independent brake demand and the data representing an automatic brake demand.

Clause 9: A brake control system for a train having a lead locomotive or control car, at least one trailing locomotive or control car and, optionally, at least one railroad car, the system comprising: on the at least one trailing locomotive or control car: an on-board computer programmed or configured to implement or facilitate at least one train action; and a communication device in communication with the on-board computer and programmed or configured to receive, transmit, and/or process data signals; wherein the communication device of the at least one trailing locomotive or control car is programmed or configured to receive data representing an independent brake demand and data representing an automatic brake demand; and wherein the on-board computer of the at least one trailing locomotive or control car is programmed or configured to control a brake cylinder pressure of the at least one trailing locomotive or control car based on the data representing an independent brake demand and the data representing an automatic brake demand.

Clause 10: The brake control system of clause 9, wherein the at least one trailing locomotive or control car is operating in an electronically-controlled pneumatic (ECP) brake mode.

Clause 11: The brake control system of clause 9 or 10, wherein the data representing an independent brake demand defines a percentage application of the independent brake demand.

Clause 12: The brake control system of any of clauses 9-11, wherein the data representing an automatic brake demand defines a percentage application of the automatic brake demand.

Clause 13: The brake control system of any of clauses 9-12, wherein the communication device of the at least one trailing locomotive or control car is programmed or configured to receive the data representing an independent brake demand and the data representing an automatic brake demand via an electronically-controlled pneumatic (ECP) brake trainline connecting the lead locomotive or control car to the at least one trailing locomotive or control car.

Clause 14: A brake control system for a train having a lead locomotive or control car, at least one trailing locomotive or control car and, optionally, at least one railroad car, the lead locomotive or control car and the at least one trailing locomotive or control car connected by a brake pipe and a control pipe, the system comprising: on the lead locomotive or control car: an on-board computer programmed or configured to implement or facilitate at least one train action; and a communication device in communication with the on-board computer and programmed or configured to receive, transmit, and/or process data signals; wherein the on-board computer of the lead locomotive or control car is programmed or configured to determine if the lead locomotive or control car is in an electronically-controlled pneumatic (ECP) brake mode; wherein, if the lead locomotive or control car is in the ECP brake mode, the on-board computer of the lead locomotive or control car is programmed or configured to generate data representing an independent brake demand based at least partially on a position of an independent brake handle of the lead locomotive or control car and data representing an automatic brake demand based at least partially on a position of an automatic brake handle of the lead locomotive or control car, and the communication device of the lead locomotive or control car is programmed or configured to transmit the data representing an independent brake demand and the data representing an automatic brake demand to the at least one trailing locomotive or control car; and wherein, if the lead locomotive is not in the ECP brake mode, the on-board computer of the lead locomotive or control car is programmed or configured to control a brake cylinder pressure of the lead locomotive or control car based on a pressure of the brake pipe, a pressure of the control pipe, and a multiplier associated with the lead locomotive.

Clause 15: The brake control system of clause 14, wherein the communication device of the lead locomotive or control car is programmed or configured to directly or indirectly transmit the data representing an independent brake demand and the data representing an automatic brake demand to the at least one trailing locomotive or control car via an ECP brake trainline connecting the lead locomotive or control car to the at least one trailing locomotive or control car.

Clause 16: The brake control system of clause 14 or 15, wherein the data representing an independent brake demand defines a percentage application of the independent brake demand, and wherein the data representing an automatic brake demand defines a percentage application of the automatic brake demand.

Clause 17: The brake control system of any of clauses 14-16, further comprising: on the at least one trailing locomotive or control car: an on-board computer programmed or configured to implement or facilitate at least one train action; and a communication device in communication with the on-board computer and programmed or configured to receive, transmit, and/or process data signals; wherein the on-board computer of the at least one trailing locomotive or control car is programmed or configured to determine if the at least one trailing locomotive or control car is in the electronically-controlled pneumatic (ECP) brake mode; wherein, if the at least one trailing locomotive or control car is in the ECP brake mode, the on-board computer of the at least one trailing locomotive is programmed or configured to determine if an ECP communications path is active, and wherein if the ECP communications path is active the communication device of the at least one trailing locomotive or control car is programmed or configured to receive the data representing an independent brake demand and the data representing an automatic brake demand via the ECP communications path, and the on-board computer of the at least one trailing locomotive or control car is programmed or configured to control a brake cylinder pressure of the at least one trailing locomotive or control car based on the data representing an independent brake demand and the data representing an automatic brake demand; and wherein, if the at least one trailing locomotive is not in the ECP brake mode or the ECP communications path is not active, the on-board computer of the at least one trailing locomotive is programmed or configured to control the brake cylinder pressure based on the pressure of the brake pipe, the pressure of the control pipe, and a multiplier associated with the at least one trailing locomotive.

Clause 18: A brake control system for a train having a lead locomotive or control car, at least one trailing locomotive or control car and, optionally, at least one railroad car, the lead locomotive or control car and the at least one trailing locomotive or control car connected by a brake pipe and a control pipe, the system comprising: on the at least one trailing locomotive or control car: an on-board computer programmed or configured to implement or facilitate at least one train action; and a communication device in communication with the on-board computer and programmed or configured to receive, transmit, and/or process data signals; wherein the on-board computer of the at least one trailing locomotive or control car is programmed or configured to determine if the at least one trailing locomotive or control car is in an electronically-controlled pneumatic (ECP) brake mode; wherein, if the at least one trailing locomotive or control car is in the ECP brake mode, the on-board computer of the at least one trailing locomotive is programmed or configured to determine if an ECP communications path is active, wherein if the ECP communications path is active, the communication device of the at least one trailing locomotive or control car is programmed or configured to receive data representing an independent brake demand and data representing an automatic brake demand via the ECP communications path, and the on-board computer of the at least one trailing locomotive or control car is programmed or configured to control a brake cylinder pressure of the at least one trailing locomotive or control car based on the data representing an independent brake demand and the data representing an automatic brake demand; and wherein, if the at least one trailing locomotive is not in the ECP brake mode or the ECP communications path is not active, the on-board computer of the at least one trailing locomotive is programmed or configured to control the brake cylinder pressure based on a pressure of the brake pipe, a pressure of the control pipe, and a multiplier associated with the at least one trailing locomotive.

Clause 19: The brake control system of clause 18, wherein the communication device of the at least one trailing locomotive or control car is programmed or configured to receive the data representing an independent brake demand and the data representing an automatic brake demand via an ECP brake trainline connecting the lead locomotive or control car to the at least one trailing locomotive or control car.

Clause 20: The brake control system of clause 18 or 19, wherein the data representing an independent brake demand defines a percentage application of the independent brake demand, and wherein the data representing an automatic brake demand defines a percentage application of the automatic brake demand.

Clause 21: A computer-implemented method for brake control for a train having a lead locomotive or control car, at least one trailing locomotive or control car and, optionally, at least one railroad car, the method comprising: generating data representing an independent brake demand and data representing an automatic brake demand; and directly or indirectly transmitting the data representing an independent brake demand and the data representing an automatic brake demand to the at least one trailing locomotive or control car.

Clause 22: The method of clause 21, wherein the lead locomotive or control car is operating in an electronically-controlled pneumatic (ECP) brake mode.

Clause 23: The method of clause 21 or 22, wherein the data representing an independent brake demand defines a percentage application of the independent brake demand, and wherein the data representing an automatic brake demand defines a percentage application of the automatic brake demand.

Clause 24: The method of any of clauses 21-23, further comprising: controlling a pressure in a brake pipe connecting the lead locomotive or control car to the at least one trailing locomotive or control car to remain charged; and controlling a pressure in a control pipe connecting the lead locomotive or control car to the at least one trailing locomotive or control car based on the independent brake demand and the automatic brake demand.

Clause 25: The method of any of clauses 21-24, further comprising directly or indirectly transmitting the data representing an independent brake demand and the data representing an automatic brake demand to the at least one trailing locomotive or control car via an electronically-controlled pneumatic (ECP) brake trainline connecting the lead locomotive or control car to the at least one trailing locomotive or control car.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1A is a schematic view of a train control system according to the principles of the present invention;

FIG. 1B is a schematic view of a train control system according to principles of the present invention; and

FIG. 2 is a flow chart illustrating a train brake control method according to principles of the present invention.

### DETAILED DESCRIPTION OF THE INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. It is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

As used herein, the terms “communication” and “communicate” refer to the receipt, transmission, or transfer of one or more signals, messages, commands, or other type of data. For one unit or device to be in communication with another unit or device means that the one unit or device is able to receive data from and/or transmit data to the other unit or device. A communication may use a direct or indirect connection, and may be wired and/or wireless in nature. Additionally, two units or devices may be in communication with each other even though the data transmitted may be modified, processed, routed, etc., between the first and second unit or device. For example, a first unit may be in communication with a second unit even though the first unit passively receives data, and does not actively transmit data to the second unit. As another example, a first unit may be in communication with a second unit if an intermediary unit processes data from one unit and transmits processed data to the second unit. It will be appreciated that numerous other arrangements are possible. Any known electronic communication protocols and/or algorithms may be used such as, for example, TCP/IP (including HTTP and other protocols), WLAN (including 802.11 and other radio frequency-based protocols and methods), analog transmissions, and/or the like. It is to be noted that a “communication device” includes any device that facilitates communication (whether wirelessly or hard-wired (e.g., over the rails of a track, over a trainline extending between railcars of a train, and the like)) between two units, such as two locomotive units or control cars. In one preferred and non-limiting embodiment or aspect, the “communication device” is a radio transceiver programmed, configured, or adapted to wirelessly transmit and receive radio frequency signals and data over a radio signal communication path.

The present invention, including the various computer-implemented and/or computer-designed aspects and configures, may be implemented on a variety of computing devices and systems, wherein these computing devices include the appropriate processing mechanisms and computer-readable media for storing and executing computer-readable instructions, such as programming instructions, code, and the like. In addition, aspects of this invention may be implemented on existing controllers, control systems, and computers integrated or associated with, or positioned on, a locomotive or control car and/or any of the railroad cars. For example, the presently-invented system or any of its functional components can be implemented wholly or partially on a train management computer, a Positive Train Control computer, an on-board controller or computer, a railroad car computer, and the like. In addition, the presently-invented systems and methods may be implemented in a laboratory environment in one or more computers or servers. Still further, the functions and computer-implemented features of the present invention may be in the form of software, firmware, hardware, programmed control systems, microprocessors, and the like.

The control system and computer-implemented control method described and claimed herein may be implemented in a variety of systems and vehicular networks; however, the systems and methods described herein are particularly useful in connection with a railway system and network. Accordingly, the presently-invented methods and systems can be implemented in various known train control and management systems, e.g., the I-ETMS® of Wabtec Corp. The systems and methods described herein are useful in connection with and/or at least partially implemented on one or more locomotives or control cars (L) that make up a train (TR). It should be noted that multiple locomotives or control cars (L) may be included in the train (TR) to facilitate the reduction of the train (TR) to match with passenger (or some other) demand or requirement. Further, the method and systems described herein can be used in connection with commuter trains, freight trains, push-pull train configurations, and/or other train arrangements and systems. Still further, the train (TR) may be separated into different configurations (e.g., other trains (TR)) and moved in either a first direction and/or a second direction. Any configuration or arrangement of locomotives, control cars, and/or railroad cars may be designated as a train and/or a consist. Still further, it is to be expressly understood that the presently-invented methods and systems described herein may be implemented on and/or used in connection with an auxiliary vehicle, such as an auxiliary railroad vehicle, a maintenance vehicle or machine, a road vehicle (e.g., truck, pick-up truck, car, or other machine), a vehicle equipped to ride on the rails of the track, and/or the like.

In one preferred and non-limiting embodiment or aspect, the methods and systems described herein are used in connection with the locomotives or controls cars (L) that are positioned on each end of the train (TR), while in other preferred and non-limiting embodiments, the methods and systems described herein are used in connection with locomotives or control cars (L) that are positioned intermediately in the train (TR) (since these intermediate locomotives or control cars (L) may eventually become a controlling locomotive or control car (L) when the train (TR) is reconfigured). It is also noted that the methods and systems described herein may be used in connection with “electrical multiple unit” (EMU) or “diesel multiple unit” (DMU) configurations, where a locomotive does not technically exist, but multiple control cars would still be present. Still further, the train (TR) may include only one locomotive or control car (L) and/or some or no railroad cars. Also, as discussed above, the methods and systems described herein may be used in connection with any vehicle type operating in the railway network.

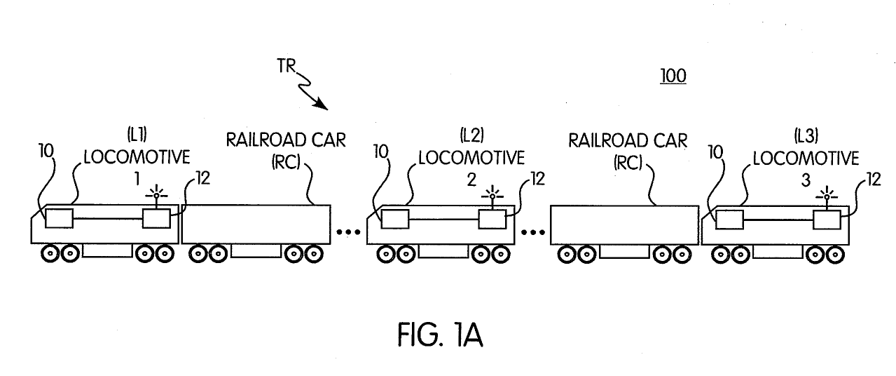

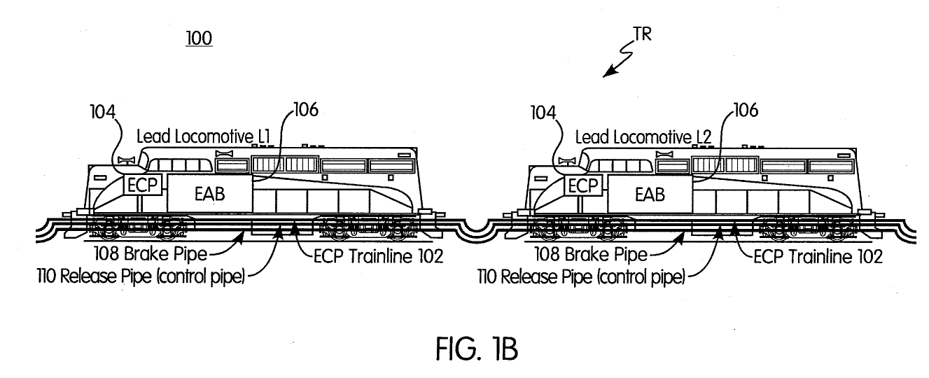

With specific reference to FIGS. 1A and 1B, and in one preferred and non-limiting embodiment or aspect, provided is a train brake control system 100 for a train TR including a plurality of locomotive or control cars (L1, L2, L3) and, optionally, a plurality of railcars (RC). Some embodiments may include additional or fewer locomotives (L) and/or control cars (RC). The locomotives (L1, L2, L2) and the optional railcars (RC) are connected to an electronically-controlled pneumatic (ECP) trainline 102, such that data signals and power signals can be provided on and over the ECP trainline 102. Alternatively to the use of a trainline, radio communication control or some other wireless communication protocol can be utilized between the locomotives (L) and/or the railcars (RC). The locomotives (L1, L2, L3) are equipped with at least an on-board computer 10 programmed or configured to implement or facilitate at least one train action and a communication device 12 in communication with the on-board computer 10 and programmed or configured to receive, transmit, and/or process data signals. While the communication device 12 may be in the form of a wireless communication device (as illustrated in FIG. 1A), as discussed herein, this communication device 12 may also be programmed or configured to transmit, process, and/or receive signals over a trainline (e.g., FIG. 1B), using an ECP component, over the rails, and/or the like.

In one preferred and non-limiting embodiment or aspect, and with reference to FIG. 1B, the on-board computers 10 and communication devices 12 of the locomotives (L1, L2, L3) include or are integrated with an ECP controller or system 104 configured to monitor and transmit data signals and power signals on the ECP trainline 102 and control ECP operations/braking and an electronic air brake (EAB) controller or system 106 configured to monitor a pressure of a brake pipe 108, and a pressure of a control pipe 110 and control automatic air brake operations and independent braking operations. The ECP controller 104 is programmed or configured to communicate with the EAB controller 106 (and vice-versa), and the ECP controller 104 is programmed or configured to communicate with other train devices, components, and systems through the ECP trainline 102 or another communications protocol. The EAB controller 106 is programmed or configured to communicate with other train devices, components, and systems, such as the I-ETMS® of Wabtec Corp. For example, the EAB controller 106 may be implemented as various known electronic air brake systems, such as the Fastbreak™ electronic airbrake of Wabtec Corp.

The brake pipe 108 interconnects the lead locomotive (L1) and the trailing locomotive(s) (L2) (and optional railcars (RC)). The independent apply and release pipe or control pipe 110 interconnects the lead locomotive (L1) and the trailing locomotive(s) (L2) (and optional railcars (RC)). These two pipes operate two separate brake systems when a train is operating in pneumatic mode, i.e., automatic braking and independent braking. The pressure of the brake pipe 108 and the pressure of the control pipe 110 are monitored by the EAB controller 106. The brake pipe 108 is controlled through an operator's automatic brake handle and controls a train-wide brake application in an inverse fashion, for example, for a given reduction in brake pipe pressure, an equal brake cylinder pressure is generated at both the lead and trailing locomotives (L1, L2), regardless of the class of the locomotive. The control pipe 110 communicates a control pressure between the lead locomotive (L1) and the close-coupled trailing locomotive(s) (L2) for purposes of controlling the brake cylinder pressures of the trailing locomotive(s) (L2) in response to independent braking. This pressure is generated at the lead locomotive (L1) by movement of an operator's independent brake handle, and generates a pressure proportional to the handle position from 0 PSI (in the release position) to typically about 45 PSI (at the full-apply position). The EAB controller 106 of each locomotive (L1, L2) senses this pressure and applies a local multiplier to the sensed control pressure to generate a resulting brake cylinder pressure, and applies the brake cylinder pressure to the brake cylinder to implement braking. When operating in pneumatic mode, the control pipe 110 is dedicated to independent braking, but when operating in ECP mode, this same control pipe 110 is used for both independent braking and automatic braking.

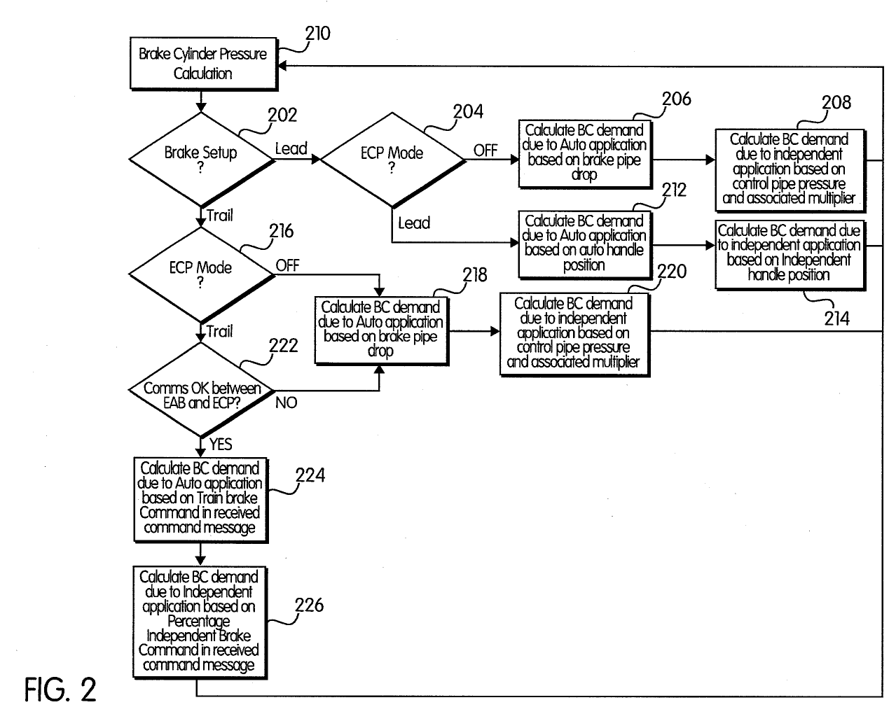

Referring now to FIG. 2, and with continued reference to FIGS. 1A and 1B, the on-board computer 10 of a locomotive (L1, L2) is configured to determine whether the locomotive (L1, L2) is a lead locomotive or a trail locomotive in scenario 202. For a locomotive that is determined to be a lead locomotive, the on-board computer 10 of the lead locomotive or control car (L1) is programmed or configured to determine if the lead locomotive or control car (L1) is in an ECP brake mode in scenario 204. For example, the ECP controller 104 of the lead locomotive (L1) can determine that the operating mode of the lead locomotive (L1) is in a lead ECP mode or a conventional or pneumatic mode. If the lead locomotive or control car (L1) is determined to not be in an ECP brake mode, the on-board computer 10 of the lead locomotive or control car (L1) is programmed or configured to control a brake cylinder pressure of the lead locomotive or control car (L1) based on a pressure of the brake pipe 108, a pressure of the control pipe 110, and a multiplier associated with the lead locomotive (L1). For example, the ECP controller 104 of the lead locomotive (L1) transmits data on the ECP trainline 102, and the EAB controller 106 of the lead locomotive (L1) is programmed or configured to calculate a brake cylinder demand due to an automatic brake application based on a drop in brake pipe pressure in scenario 206. The EAB controller 106 of the lead locomotive (L2) is programmed or configured to calculate a brake cylinder demand due an independent brake application based on control pipe pressure and a multiplier associated with the lead locomotive (L1) in scenario 208.

For example, the multiplier is applied to the control pipe pressure to adjust the brake cylinder demand due to the independent brake application for the particular locomotive. In scenario 201, the EAB controller 106 of the lead locomotive (L1) calculates a total brake cylinder pressure based on the calculated demand due to the automatic brake application and the calculated demand due to the independent brake application, e.g., by adding the calculated demands together, and controls the application of the pressure to the brake cylinder.

If the lead locomotive or control car (L1) is determined to be in an ECP brake mode in scenario 204, the on-board computer 10 of the lead locomotive or control car (L1) is programmed or configured to generate data representing an independent brake demand based at least partially on a position of an independent brake handle of the lead locomotive or control car (L1) and data representing an automatic brake demand based at least partially on a position of an automatic brake handle of the lead locomotive or control car (L1). The communication device 12 of the lead locomotive or control car (L1) is programmed or configured to transmit the data representing an independent brake demand and the data representing an automatic brake demand to the at least one trailing locomotive or control car (L2), and the at least one on-board computer 10 of the lead locomotive (L1) controls a pressure in the brake pipe 108 connecting the lead locomotive or control car (L1) to the at least one trailing locomotive or control car (L2) to remain charged and controls a pressure in the control pipe 110 connecting the lead locomotive or control car (L1) to the at least one trailing locomotive or control car (L2) based on the independent brake demand and the automatic brake demand.

For example, the ECP controller 104 of the lead Locomotive (L1) is configured to calculate the brake cylinder demand due to an automatic brake application based at least partially on a position of the automatic brake handle in scenario 212, which is monitored by the ECP controller 104 and/or the EAB controller 106 of the lead locomotive (L1), and calculate the brake cylinder demand due to an independent brake application based at least partially on a position of the independent brake handle in scenario 214, which is monitored by the ECP controller 104 and/or the EAB controller 106 of the lead locomotive (L1). The data representing an independent brake demand can define a percentage application of the independent brake demand, and the data representing an automatic brake demand can define a percentage application of the automatic brake demand. In scenario 210, the EAB controller 106 of the lead locomotive (L1) calculates a total brake cylinder pressure based on the calculated demand due to the automatic brake application based at least partially on the position of the automatic brake handle and the calculated demand due to the independent brake application based at least partially on the position of the independent handle, e.g., by adding the calculated demands together, and controls the application of the brake cylinder pressure to the brake cylinder.

In one preferred and non-limiting embodiment or aspect, the ECP controller 104 of the lead locomotive (L1) is programmed configured to transmit the data representing an independent brake demand and the data representing an automatic brake demand to the at least one trailing locomotive or control car (L2) via the ECP brake trainline 102 connecting the lead locomotive or control car (L1) to the at least one trailing locomotive or control car (L2). For example, the ECP controller 104 of the lead locomotive (L1) can transmit the percentage application of independent brake demand in addition to a current Train Brake Command (TBC), which defines the automatic brake percentage demand while in ECP. The TBC value is already part of conventional ECP message structure, but no processes are provided in the conventional structure for independent brake demand. The ECP controller 104 modifies the ECP command message, which already includes the TBC defining the automatic brake percentage demand, to include the percentage application of independent brake demand.

In one preferred and non-limiting embodiment or aspect, and by receiving both demands, the close-coupled trailing locomotive(s) (L2) can discern what the proper brake cylinder pressure application should be based on the data as described in more detail below. For example, the trailing locomotive(s) (L2) can apply the multiplier to only the percentage of the brake cylinder pressure that corresponds to independent braking. The lead locomotive (L1) also controls the pressure in the control pipe 110 during the automatic and independent brake applications, and this pressure can serve as a backup signal for “Reduced Mode” brake demands, in the event that there is a fault such as a communication interruption between the lead locomotive (L1) and the trailing locomotive(s) (L2).

For a locomotive that is determined to be a trailing locomotive in scenario 202, the on-board computer 10 of the trailing locomotive or control car (L2) is programmed or configured to determine if the trailing locomotive or control car (L2) is in an ECP brake mode in scenario 216. For example, the ECP controller 104 of the trailing locomotive (L2) can determine that the operating mode of the trailing locomotive (L2) is a trail ECP mode or a conventional or pneumatic mode. If the trailing locomotive or control car (L2) is not in an ECP brake mode, the on-board computer 10 of the at least one trailing locomotive (L2) is programmed or configured to control the brake cylinder pressure based on the pressure of the brake pipe 108, the pressure of the control pipe 110, and a multiplier associated with the at least one trailing locomotive.

In one preferred and non-limiting embodiment or aspect, the EAB controller 106 of the trailing locomotive (L2) calculates a brake cylinder demand due to an automatic brake application based on a drop in brake pipe pressure, which is monitored by the EAB controller 106 of the trailing locomotive (L2), in scenario 218. The EAB controller 106 of the trailing locomotive (L2) calculates the brake cylinder demand due to an independent brake application based on a pressure of the control pipe 110, which is monitored by the EAB controller 106 of the trailing locomotive (L2), and a multiplier associated with the trailing locomotive (L2) in scenario 220. For example, the multiplier is applied to the control pipe pressure to adjust the brake cylinder demand due to the independent brake application for the particular locomotive. In scenario 210, the EAB controller 106 of the trailing locomotive (L2) calculates a total brake cylinder pressure based on the calculated demand due to the automatic brake application and the calculated demand due to the independent brake application, e.g., by adding the calculated demands together, and controls the application of the brake cylinder pressure to the brake cylinder.

If it is determined in scenario 216 that the at least one trailing locomotive or control car (L2) is in an ECP brake mode, the on-board computer 10 of the at least one trailing locomotive (L2) is programmed or configured to determine if an ECP communications path is active. For example, the ECP controller 104 of the trailing locomotive (L2) is programmed or configured to determine if communications over the ECP trainline 102 or radio communications with the ECP controller 104 of the lead locomotive (L1) are available and functioning properly in scenario 222.

If it is determined in scenario 222 that the ECP communications path is not active, the on-board computer 10 of the at least one trailing locomotive (L2) is programmed or configured to control the brake cylinder pressure based on the pressure of the brake pipe 108, the pressure of the control pipe 110, and a multiplier associated with the at least one trailing locomotive (L2). For example, the EAB controller 106 of the trailing locomotive (L2) calculates a brake cylinder demand due to an automatic brake application based on a drop in brake pipe pressure, which is monitored by the EAB controller 106 of the trailing locomotive (L2), in scenario 218. The EAB controller 106 of the trailing locomotive (L2) calculates the brake cylinder demand due to an independent brake application based on a pressure of the control pipe 110, which is monitored by the EAB controller 106 of the trailing locomotive (L2), and a multiplier associated with the trailing locomotive (L2) in scenario 220. For example, the multiplier is applied to the control pipe pressure to adjust the brake cylinder demand due to the independent brake application for the particular locomotive.

If it is determined in scenario 222 that the ECP communications path is active, the communication device 12 of the at least one trailing locomotive or control car (L2) is programmed or configured to receive the data representing an independent brake demand and the data representing an automatic brake demand from the lead locomotive (L1) via the ECP communications path. The on-board computer 10 of the at least one trailing locomotive or control car (L2) is programmed or configured to control a brake cylinder pressure of the at least one trailing locomotive or control car (L2) based on the data representing an independent brake demand and the data representing an automatic brake demand. For example, the ECP controller 104 of the trailing locomotive(s) (L2) is programmed or configured to receive the data representing an independent brake demand and the data representing an automatic brake demand via the ECP communications path, e.g., as part of a command message.

In scenario 224, the ECP controller 104 of the trailing locomotive(s) (L2) is programmed or configured to calculate the brake cylinder demand due to the automatic brake application based on the TBC command received in the command message, which is based at least partially on the position of the automatic brake handle in the lead locomotive (L1). In scenario 226, the ECP controller 104 of the trailing locomotive(s) (L2) is programmed or configured to calculate the brake cylinder demand due to the independent brake application based on the percentage independent brake command in the received command message, which is based at least partially on the position of the independent brake handle in the lead locomotive (L1). The ECP controller 104 and the EAB controller 106 can thus avoid applying the multiplier to demand that is present in the control pipe due to automatic braking demand by instead calculating the brake cylinder pressure based on the percentage automatic brake command and percentage independent brake command received from the lead locomotive (L1). In scenario 210, the EAB controller 106 of the trailing locomotive (L2) calculates a total brake cylinder pressure based on the calculated demand due to the automatic brake application and the calculated demand due to the independent brake application, e.g., by adding the calculated demands together, and controls the application of the brake cylinder pressure to the brake cylinder.

In this manner, preferred and non-limiting embodiments provide an improved brake control system and method for a train. The pressure generated by an ECP Trail unit for a given ECP automatic brake train brake command (TBC) percentage demand matches that pressure that would have been generated by a system operating in a conventional mode that has sensed a reduction in brake pipe pressure, equivalent to the given TBC value. The pressure generated by an ECP Trail unit for a given ECP independent brake percentage demand matches that pressure which would have been generated by a system operating in a conventional mode that has sensed a control pipe pressure, equivalent to the given independent percentage value, multiplied by the local multiplier.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A brake control system for a train having a lead locomotive or control car, at least one trailing locomotive or control car and, optionally, at least one railroad car, the system comprising:
on the lead locomotive or control car:
an on-board computer programmed or configured to implement or facilitate at least one train action; and
a communication device in communication with the on-board computer and programmed or configured to receive, transmit, and/or process data signals;
wherein the on-board computer of the lead locomotive or control car is programmed or configured to generate data representing an independent brake demand and data representing an automatic brake demand; and
wherein the communication device of the lead locomotive or control car is programmed or configured to directly or indirectly transmit the data representing an independent brake demand and the data representing an automatic brake demand to the at least one trailing locomotive or control car.

2. The brake control system of claim 1, wherein the lead locomotive or control car is operating in an electronically-controlled pneumatic (ECP) brake mode.

3. The brake control system of claim 1, wherein the data representing an independent brake demand defines a percentage application of the independent brake demand.

4. The brake control system of claim 1, wherein the data representing an automatic brake demand defines a percentage application of the automatic brake demand.

5. The brake control system of claim 1, wherein the on-board computer of the lead locomotive or control car is programmed or configured to: control a pressure in a brake pipe connecting the lead locomotive or control car to the at least one trailing locomotive or control car to remain charged; and control a pressure in a control pipe connecting the lead locomotive or control car to the at least one trailing locomotive or control car based on the independent brake demand and the automatic brake demand.

6. The brake control system of claim 1, wherein the communication device of the lead locomotive or control car is programmed or configured to directly or indirectly transmit the data representing an independent brake demand and the data representing an automatic brake demand to the at least one trailing locomotive or control car via an electronically-controlled pneumatic (ECP) brake trainline connecting the lead locomotive or control car to the at least one trailing locomotive or control car.

7. The brake control system of claim 1, wherein the on-board computer of the lead locomotive or control car is programmed or configured to generate the data representing an independent brake demand based at least partially on a position of an independent brake handle of the lead locomotive or control car, and generate the data representing an automatic brake demand based at least partially on the position of an automatic brake handle of the lead locomotive or control car.

8. The brake control system of claim 1, further comprising:
on the at least one trailing locomotive or control car:
an on-board computer programmed or configured to implement or facilitate at least one train action; and
a communication device in communication with the on-board computer and programmed or configured to receive, transmit, and/or process data signals;
wherein the communication device of the at least one trailing locomotive or control car is programmed or configured to receive the data representing an independent brake demand and the data representing an automatic brake demand; and
wherein the on-board computer of the at least one trailing locomotive or control car is programmed or configured to control a brake cylinder pressure of the at least one trailing locomotive or control car based on the data representing an independent brake demand and the data representing an automatic brake demand.

9. A brake control system for a train having a lead locomotive or control car, at least one trailing locomotive or control car and, optionally, at least one railroad car, the system comprising:
on the at least one trailing locomotive or control car:
an on-board computer programmed or configured to implement or facilitate at least one train action; and
a communication device in communication with the on-board computer and programmed or configured to receive, transmit, and/or process data signals;
wherein the communication device of the at least one trailing locomotive or control car is programmed or configured to receive data representing an independent brake demand and data representing an automatic brake demand; and
wherein the on-board computer of the at least one trailing locomotive or control car is programmed or configured to control a brake cylinder pressure of the at least one trailing locomotive or control car based on the data representing an independent brake demand and the data representing an automatic brake demand.

10. The brake control system of claim 9, wherein the at least one trailing locomotive or control car is operating in an electronically-controlled pneumatic (ECP) brake mode.

11. The brake control system of claim 9, wherein the data representing an independent brake demand defines a percentage application of the independent brake demand.

12. The brake control system of claim 9, wherein the data representing an automatic brake demand defines a percentage application of the automatic brake demand.

13. The brake control system of claim 9, wherein the communication device of the at least one trailing locomotive or control car is programmed or configured to receive the data representing an independent brake demand and the data representing an automatic brake demand via an electronically-controlled pneumatic (ECP) brake trainline connecting the lead locomotive or control car to the at least one trailing locomotive or control car.

14. A brake control system for a train having a lead locomotive or control car, at least one trailing locomotive or control car and, optionally, at least one railroad car, the lead locomotive or control car and the at least one trailing locomotive or control car connected by a brake pipe and a control pipe, the system comprising:
on the lead locomotive or control car:
an on-board computer programmed or configured to implement or facilitate at least one train action; and
a communication device in communication with the on-board computer and programmed or configured to receive, transmit, and/or process data signals;
wherein the on-board computer of the lead locomotive or control car is programmed or configured to determine if the lead locomotive or control car is in an electronically-controlled pneumatic (ECP) brake mode;
wherein, if the lead locomotive or control car is in the ECP brake mode, the on-board computer of the lead locomotive or control car is programmed or configured to generate data representing an independent brake demand based at least partially on a position of an independent brake handle of the lead locomotive or control car and data representing an automatic brake demand based at least partially on a position of an automatic brake handle of the lead locomotive or control car, and the communication device of the lead locomotive or control car is programmed or configured to transmit the data representing an independent brake demand and the data representing an automatic brake demand to the at least one trailing locomotive or control car; and
wherein, if the lead locomotive is not in the ECP brake mode, the on-board computer of the lead locomotive or control car is programmed or configured to control a brake cylinder pressure of the lead locomotive or control car based on a pressure of the brake pipe, a pressure of the control pipe, and a multiplier associated with the lead locomotive.

15. The brake control system of claim 14, wherein the communication device of the lead locomotive or control car is programmed or configured to directly or indirectly transmit the data representing an independent brake demand and the data representing an automatic brake demand to the at least one trailing locomotive or control car via an ECP brake trainline connecting the lead locomotive or control car to the at least one trailing locomotive or control car.

16. The brake control system of claim 14, wherein the data representing an independent brake demand defines a percentage application of the independent brake demand, and wherein the data representing an automatic brake demand defines a percentage application of the automatic brake demand.

17. The brake control system of claim 14, further comprising:
on the at least one trailing locomotive or control car:
an on-board computer programmed or configured to implement or facilitate at least one train action; and
a communication device in communication with the on-board computer and programmed or configured to receive, transmit, and/or process data signals;
wherein the on-board computer of the at least one trailing locomotive or control car is programmed or configured to determine if the at least one trailing locomotive or control car is in the electronically-controlled pneumatic (ECP) brake mode;
wherein, if the at least one trailing locomotive or control car is in the ECP brake mode, the on-board computer of the at least one trailing locomotive is programmed or configured to determine if an ECP communications path is active, and wherein if the ECP communications path is active the communication device of the at least one trailing locomotive or control car is programmed or configured to receive the data representing an independent brake demand and the data representing an automatic brake demand via the ECP communications path, and the on-board computer of the at least one trailing locomotive or control car is programmed or configured to control a brake cylinder pressure of the at least one trailing locomotive or control car based on the data representing an independent brake demand and the data representing an automatic brake demand; and
wherein, if the at least one trailing locomotive is not in the ECP brake mode or the ECP communications path is not active, the on-board computer of the at least one trailing locomotive is programmed or configured to control the brake cylinder pressure based on the pressure of the brake pipe, the pressure of the control pipe, and a multiplier associated with the at least one trailing locomotive.

18. A brake control system for a train having a lead locomotive or control car, at least one trailing locomotive or control car and, optionally, at least one railroad car, the lead locomotive or control car and the at least one trailing locomotive or control car connected by a brake pipe and a control pipe, the system comprising:
on the at least one trailing locomotive or control car:
an on-board computer programmed or configured to implement or facilitate at least one train action; and
a communication device in communication with the on-board computer and programmed or configured to receive, transmit, and/or process data signals;
wherein the on-board computer of the at least one trailing locomotive or control car is programmed or configured to determine if the at least one trailing locomotive or control car is in an electronically-controlled pneumatic (ECP) brake mode;
wherein, if the at least one trailing locomotive or control car is in the ECP brake mode, the on-board computer of the at least one trailing locomotive is programmed or configured to determine if an ECP communications path is active, wherein if the ECP communications path is active, the communication device of the at least one trailing locomotive or control car is programmed or configured to receive data representing an independent brake demand and data representing an automatic brake demand via the ECP communications path, and the on-board computer of the at least one trailing locomotive or control car is programmed or configured to control a brake cylinder pressure of the at least one trailing locomotive or control car based on the data representing an independent brake demand and the data representing an automatic brake demand; and
wherein, if the at least one trailing locomotive is not in the ECP brake mode or the ECP communications path is not active, the on-board computer of the at least one trailing locomotive is programmed or configured to control the brake cylinder pressure based on a pressure of the brake pipe, a pressure of the control pipe, and a multiplier associated with the at least one trailing locomotive.

19. The brake control system of claim 18, wherein the communication device of the at least one trailing locomotive or control car is programmed or configured to receive the data representing an independent brake demand and the data representing an automatic brake demand via an ECP brake trainline connecting the lead locomotive or control car to the at least one trailing locomotive or control car.

20. The brake control system of claim 18, wherein the data representing an independent brake demand defines a percentage application of the independent brake demand, and wherein the data representing an automatic brake demand defines a percentage application of the automatic brake demand.

21. A computer-implemented method for brake control for a train having a lead locomotive or control car, at least one trailing locomotive or control car and, optionally, at least one railroad car, the method comprising:
generating data representing an independent brake demand and data representing an automatic brake demand; and
directly or indirectly transmitting the data representing an independent brake demand and the data representing an automatic brake demand to the at least one trailing locomotive or control car.

22. The method of claim 21, wherein the lead locomotive or control car is operating in an electronically-controlled pneumatic (ECP) brake mode.

23. The method of claim 21, wherein the data representing an independent brake demand defines a percentage application of the independent brake demand, and wherein the data representing an automatic brake demand defines a percentage application of the automatic brake demand.

24. The method of claim 21, further comprising:
controlling a pressure in a brake pipe connecting the lead locomotive or control car to the at least one trailing locomotive or control car to remain charged; and
controlling a pressure in a control pipe connecting the lead locomotive or control car to the at least one trailing locomotive or control car based on the independent brake demand and the automatic brake demand.

25. The method of claim 21, further comprising directly or indirectly transmitting the data representing an independent brake demand and the data representing an automatic brake demand to the at least one trailing locomotive or control car via an electronically-controlled pneumatic (ECP) brake trainline connecting the lead locomotive or control car to the at least one trailing locomotive or control car.

26. The method of claim 21, further comprising generating the data representing an independent brake demand based at least partially on a position of an independent brake handle of the lead locomotive or control car and generate the data representing an automatic brake demand based at least partially on the position of an automatic brake handle of the lead locomotive or control car.

27. A computer-implemented method for brake control for a train having a lead locomotive or control car, at least one trailing locomotive or control car and, optionally, at least one railroad car, the method comprising:
receiving data representing an independent brake demand and data representing an automatic brake demand; and
controlling a brake cylinder pressure of the at least one trailing locomotive or control car based on the data representing an independent brake demand and the data representing an automatic brake demand.

28. The method of claim 27, wherein the at least one trailing locomotive or control car is operating in an electronically-controlled pneumatic (ECP) brake mode.

29. The method of claim 27, wherein the data representing an independent brake demand defines a percentage application of the independent brake demand, and wherein the data representing an automatic brake demand defines a percentage application of the automatic brake demand.

30. The method of claim 27, further comprising receiving the data representing an independent brake demand and the data representing an automatic brake demand via an electronically-controlled pneumatic (ECP) brake trainline connecting the lead locomotive or control car to the at least one trailing locomotive or control car.
